(19) United States
(12) Patent Application Publication
(10) Pub. No.: US 2024/0300271 A1
(43) Pub. Date: Sep. 12, 2024

(54) Tow Bar Recess Holes Protection Cover Device

(71) Applicant: Yvan Houle, Cumbereland (CA)

(72) Inventor: Yvan Houle, Cumbereland (CA)

(21) Appl. No.: 18/494,877

(22) Filed: Oct. 26, 2023

Related U.S. Application Data
(60) Provisional application No. 63/489,585, filed on Mar. 10, 2023.

(51) Int. Cl. B60D 1/60

(52) U.S. Cl. CPC B60D 1/605

(57) ABSTRACT

A protective cap device is disclosed that covers recessed areas on a vehicle used for accommodating RV tow bars during flat towing. The cap device features a circular first end and a generally rectilinear second end connected by cylindrical members. When inserted into a recess hole of the vehicle, the cap device provides a secure seal, preventing the entry of water, snow, road salt, rust, and debris into the hole. The rectilinear second end ensures a stable engagement with the recess hole's interior, even under sudden braking. The cap device is easily inserted and removed, simplifying the process of attaching and detaching tow bars. Additionally, the cap device has oil-absorbing properties which prevents rusting of the tow bar during towing operations.

### CROSS-REFERENCE TO RELATED APPLICATION

The present application claims priority to, and the benefit of, U.S. Provisional Application No. 63/489,585, which was filed on Mar. 10, 2023, and is incorporated herein by reference in its entirety.

### FIELD OF THE INVENTION

The present invention generally relates to the field of vehicle towing bars. More specifically, the present invention relates to a novel cap device cap for an RV tow bar. More specifically, the cap is for covering recessed areas on a vehicle that accommodates RV tow bars to protect the recessed area from debris buildup that can prevent the tow bar from being applied. The device comprises foam material which is absorbent such that the device can receive oil to prevent rusting of the tow bar. Accordingly, the present disclosure makes specific reference thereto. Nonetheless, it is to be appreciated that aspects of the present invention are also equally applicable to other like applications, devices, and methods of manufacture.

### BACKGROUND

By way of background, towing a vehicle behind an RV is a common practice. There are different methods for towing a vehicle, and two popular options are using tow dollies or trailers, or flat towing (also known as “four-down towing” or “dinghy towing”). Flat towing is a convenient method and involves attaching a tow bar to the front of a towed vehicle and to the rear of an RV. This allows the towed vehicle to roll along behind the RV on its own four tires. This method is suitable for vehicles that are specifically designed and approved for flat towing. Flat towing doesn't require a separate dolly or trailer, and the towed vehicle can be easily driven upon reaching a destination. Tow dollies and trailers are used for towing vehicles that cannot be flat towed. These devices typically require either the front or rear wheels of the towed vehicle to be lifted off the ground while the other wheels remain in contact with the road.

Vehicles are equipped with recess holes to be towed by an RV. The recess holes are typically located on the front bumper or frame of the vehicle and provide a secure attachment point for the tow bar. In some vehicles, for towing, plates are installed which have similar recess holes. However, these recess holes remain open when not used for towing the vehicle and therefore, can accumulate dirt, water, snow, road salt, rust, or other debris, which can render the recess holes unusable until they are cleaned. When the recess holes are obstructed, attaching the tow bar and towing the vehicle becomes difficult, time consuming, and laborious. When the recess holes are inoperable, it can also make it difficult to apply a recess and tow bar lock, which is used to further secure the connection between the RV and the towed vehicle.

Some people use fabric or other types of materials such as foam, plastic, and the like in non-calibrated dimensions to cover the recess holes. But such materials are not only ineffective but also decrease aesthetics of a vehicle. People desire a protective covering or cap for the recessed holes on vehicles that accommodate RV tow bars.

Therefore, there exists a long felt need in the art for a cap device that serves as a protective barrier for recess holes used for accommodating RV tow bars. There is also a long felt need in the art for an RV tow bar recess holes protective device that prevents water, snow, road salt, rust, and debris from entering the recess holes and keeping them clean. Additionally, there is a long felt need in the art for a vehicle's towing recess holes protective cap that avoids the hassle and cost of cleaning the recess holes before each towing operation. Moreover, there is a long felt need in the art for a protective cap or cover that protects the recessed areas used for towing a vehicle, eliminating the need for frequent cleaning and ensuring smoother towing experiences. Further, there is a long felt need in the art for a recess hole protective cap that prevents debris buildup in towing recess holes and prevents rusting of a tow bar used with the recess holes. Furthermore, there is a long felt need in the art for a protective cap that covers a towing recess hole while improving aesthetics of a vehicle. Finally, there is a long felt need in the art for a flat tow protection cap that saves considerable time and effort when towing vehicles with an RV.

The subject matter disclosed and claimed herein, in one embodiment thereof, comprises a one-piece structure and portable flat tow recess hole protective cap device. The device is used for covering recess holes used for accommodating RV tow bars on a vehicle to protect the recess holes from water, snow, road salt, rust, and other debris. The cap device features a circular first end, a generally rectilinear opposite second end, a first cylindrical member extending from the bottom surface of the first end to a second cylindrical member, the second cylindrical member extending between the bottom surface of the first cylindrical member and the top end of the generally rectilinear second end, the generally rectilinear second end and the cylindrical members designed to insert into a recess hole disposed in a vehicle used for flat towing and accommodating the RV tow bar, the circular first end has a diameter greater than a diameter of the recess hole and abuts against the vehicular surface and thereby prevents entry of water, snow, road salt, rust, and other debris inside the recess hole.

In this manner, the flat tow recess hole protection cap of the present invention accomplishes all of the forgoing objectives and provides people with a cap for recessed areas on a vehicle that accommodates RV tow bars. The cap protects the holes from water, snow, road salt, rust, and other debris and can absorb oil, thereby preventing rusting of the tow bar. The cap keeps the recess holes clear and usable, eliminating the need for frequent cleaning and ensuring smoother towing experiences.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flat tow recess hole protective cap device for covering recessed holes used for accommodating RV tow bars on a vehicle. The cap device further comprising a one-piece structure made of a flexible and oil-absorbing foam material, a circular first end, a generally rectilinear opposite second end, a first cylindrical member extending from the bottom surface of the first end to a second cylindrical member, the second cylindrical member extending between the bottom surface of the first cylindrical member and the top end of the generally rectilinear second end, the generally rectilinear second end and the cylindrical members designed to insert into a recess hole disposed in a vehicle used for flat towing and accommodating the RV tow bar, the circular first end has a diameter greater than a diameter of the recess hole and abuts against the vehicular surface and thereby prevents entry of water, snow, road salt, rust, and other debris inside the recess hole.

In yet another embodiment, the length of the first cylindrical member is about six to twelve times the length of the second cylindrical member.

In a further embodiment, the diameter of the first cylindrical member is about two to five times the diameter of the second cylindrical member.

In yet another embodiment, the device is easily insertable into a recess hole with the generally rectilinear second end and the cylindrical members accommodated inside the hole, and the circular first end is usable for gripping the device and pulling out the device when a tow bar is to be used for towing the vehicle.

In a further embodiment, a method for protecting recess holes used for accommodating RV tow bars on a vehicle using a cap device is described. The method comprising the steps of providing a vehicle having symmetrical and identical recess holes disposed in front of the vehicle, wherein the recess holes are used for accommodating RV tow bars for flat towing the vehicle, positioning the cap device horizontally, aligning it with a recess hole, the cap device includes a rectilinear end and a circular end, a pair of cylindrical members disposed between the rectilinear end and the circular end, inserting the rectilinear end and the cylindrical members of the cap device into the recess hole, abutting the circular end of the cap device against the front surface of the vehicle, thereby sealing the recess hole, and securely engaging the rectilinear end of the cap device by abutting it against the interior of the recess hole, thereby preventing the cap device from falling even during sudden braking at high speed by the driver of the vehicle.

In a further embodiment, the method further comprising the step of preventing rusting of a tow bar inserted inside the recess holes during a towing operation by designing the cap device to absorb oil present inside the recess holes.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a flat tow recess hole protective cap of the present invention in accordance with the disclosed architecture;

FIG. 2A illustrates another perspective view showing the tapered shape of the first end of the protective cap device of the present invention in accordance with the disclosed architecture;

FIG. 2B illustrates a top perspective view of the recess hole protective cap of the present invention in accordance with the disclosed architecture;

FIG. 3 illustrates a front perspective view of a vehicle showing flat tow recess holes and orientation of the protective cover device of the present invention for insertion into the recess holes in accordance with the disclosed architecture;

FIG. 4 illustrates a perspective view showing the recess hole cap device inserted into the recess holes of the vehicle in accordance with the disclosed architecture; and

FIG. 5 illustrates a top view of another embodiment of the recess hole cap device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a cap device that serves as a protective barrier for recess holes used for accommodating RV tow bars. There is also a long felt need in the art for an RV tow bar recess holes protective device that prevents water, snow, road salt, rust, and debris from entering the recess holes and keeping them clean. Additionally, there is a long felt need in the art for a vehicle's towing recess holes protective cap that avoids the hassle and cost of cleaning the recess holes before each towing operation. Moreover, there is a long felt need in the art for a protective cap or cover that protects the recessed areas used for towing a vehicle, eliminating the need for frequent cleaning, and ensuring smoother towing experiences. Further, there is a long felt need in the art for a recess hole protective cap that prevents debris buildup in towing recess holes and prevents rusting of a tow bar used with the recess holes. Furthermore, there is a long felt need in the art for a protective cap that covers a towing recess hole while improving aesthetics of a vehicle. Finally, there is a long felt need in the art for a flat tow protection cap that saves considerable time and effort when towing vehicles with an RV.

The present invention, in one exemplary embodiment, is a flat tow protection cap for an RV tow bar. The cap has a foam-like, recessed interior area and the foam material is absorbent such that the cap can receive oil to prevent rusting of the tow bar. During use, users can apply the protection cap to cover the recessed interior areas to prevent debris buildup on the vehicle and its tow bar area. The vehicle can be easily towed by an RV and the cap saves considerable time and effort when towing vehicles with an RV while improving their aesthetics.

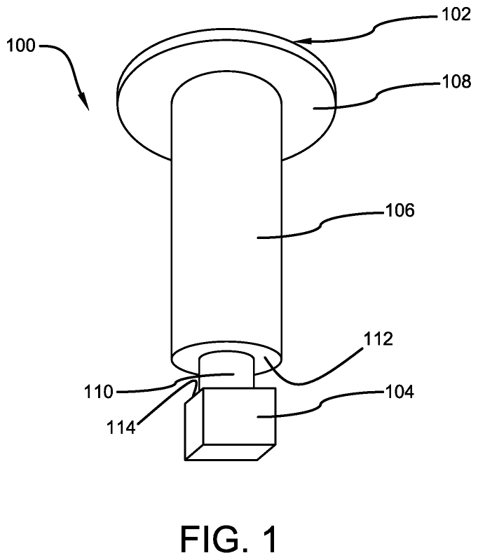

Referring initially to the drawings, FIG. 1 illustrates a perspective view of a flat tow recess hole protective cap of the present invention in accordance with the disclosed architecture. The flat tow recess hole protective cap 100 of the present invention is designed as a protective cover for covering recessed areas used for accommodating RV tow bars on a vehicle. More specifically, the recess hole cap 100 has a one-piece structure and is made of a flexible and oil-absorbing foam material. The protective cap device 100 has a circular first end 102 and a generally rectilinear second end 104. A first cylindrical member 106 extends from the bottom surface 108 of the first end 102 to a second cylindrical member 110. The second cylindrical member 110 extends between the bottom surface 112 of the first cylindrical member 106 and the top end 114 of the generally rectilinear second end 104. The length of the first cylindrical member 106 is about six to twelve times the length of the second cylindrical member 110. Further, diameter of the first cylindrical member 106 is about two to five times the diameter of the second cylindrical member 110.

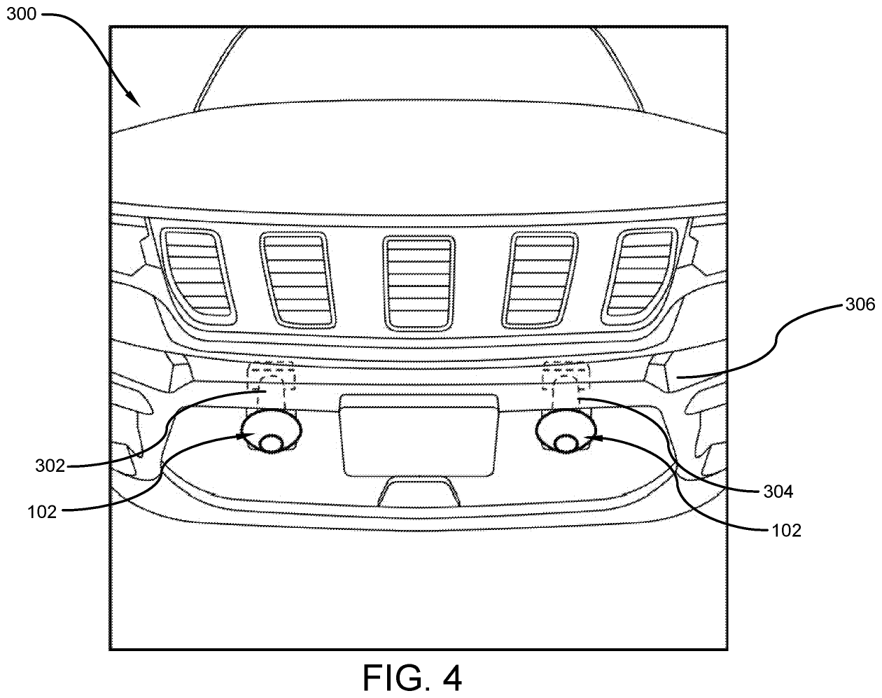

The generally rectilinear second end 104, and the cylindrical members 106, 110 are designed to insert into a recess hole disposed in a vehicle used for flat towing and accommodating the RV tow bar as illustrated in FIG. 4. The circular first end 102 abuts against the vehicular surface and prevents entry of water, snow, road salt, rust, and other debris inside the recess hole. Depending on design of the vehicle, length, and size of the protective cover 100 can be configured. Further, color of the device 100 can be configured to match the color of the vehicle with which the protective cap 100 is to be used. The device 100 can be easily inserted into a recess hole with the generally rectilinear second end 104, the cylindrical members 106, 110 accommodated inside the hole and the circular first end 102 can be used for pulling out the device 100 when a tow bar is to be used for towing the vehicle.

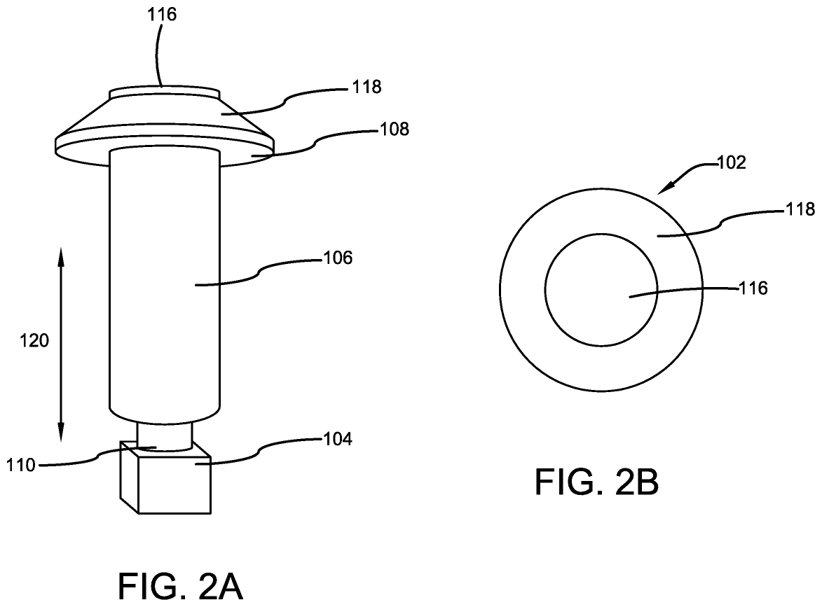

FIG. 2A illustrates another perspective view showing the tapered shape of the first end of the protective cap device of the present invention in accordance with the disclosed architecture. The first end 102 has a generally circular shape and has a circular top surface 116 whose diameter is smaller than the bottom surface 108. The first end 102 is solid and has tapered shape 118 between the top surface 116 and the bottom surface 108. The first end 102 is designed for a user to easily hold the device 100 by gripping the device 100 along the bottom surface 108. The generally rectilinear second end 104 in some of the embodiments can rotate relative to an axis 120 along the cylindrical members 106, 110. This enables a user to align the second end 104 with a recess hole for inserting the device 100 into the recess hole.

FIG. 2B illustrates a top perspective view of the recess hole protective cap of the present invention in accordance with the disclosed architecture. The top end 102 is circular and the bottom surface 108 is configured to have a diameter larger than a diameter of the recess hole which is to be covered by the device 100. The top surface 116 of the first end 102 can have a diameter ranging from 50% to 75% of the diameter of the bottom surface 108.

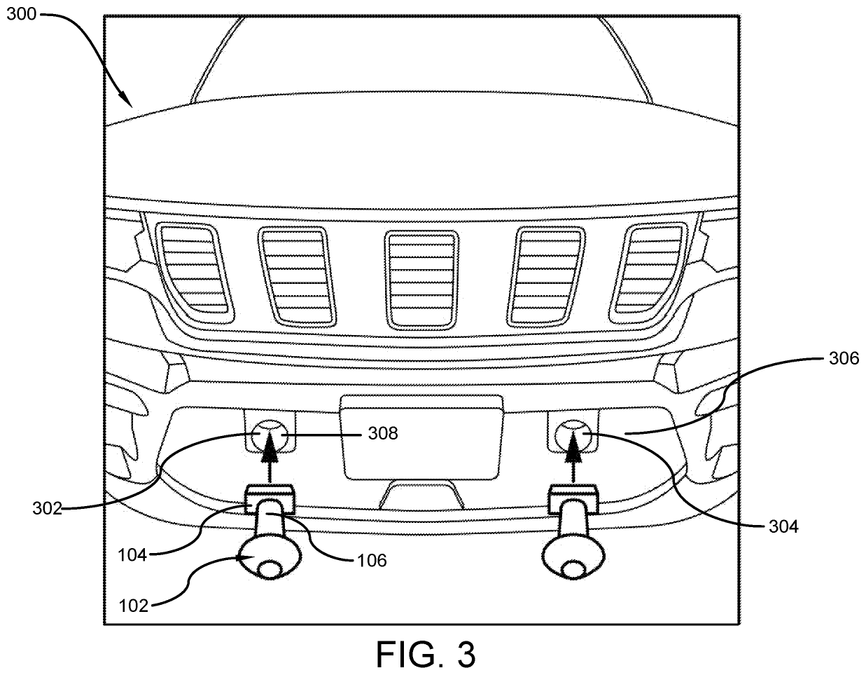

FIG. 3 illustrates a front perspective view of a vehicle showing the flat tow recess holes and orientation of the protective cover device of the present invention for insertion into the recess holes in accordance with the disclosed architecture. As illustrated, the vehicle 300 includes two symmetrical and identical recess holes 302, 304 disposed in front 306 of the vehicle 300. The recess holes 302, 304 are used for accommodating RV tow bars for flat towing the vehicle 300. When tow bars are not used, then, the cap device 100 is used for protecting the recess holes 302, 304. The following description uses recess hole 302 as an example but the process remains the same for covering the other recess hole 304. The cap device 100 is positioned horizontal (aligning with the recess hole 302) with the rectilinear second end 104 in front of the recess hole 302 such that the rectilinear second end 104 and the cylindrical members 106, 110 are inserted into the recess hole 302 and the circular end 102 having a diameter greater than the diameter of the recess hole 302 abuts against the front surface 306 of the vehicle 300, thereby sealing the recess hole 302 as illustrated in FIG. 4.

The rectilinear second end 104 makes a secure engagement by abutting against the interior 308 of the recess hole 302, thereby preventing the cap device 100 from falling even when a sudden brake is applied at high speed by a driver of the vehicle 300.

FIG. 4 illustrates a perspective view showing the recess hole cap device inserted into the recess holes of the vehicle in accordance with the disclosed architecture. As illustrated, the rectilinear second end 104 and the cylindrical members 106, 110 are inserted into the recess holes 302, 304 with the circular end 102 abutting against the front surface 306 of the vehicle 300. The circular end 102 covers the holes 302, 304, thereby preventing entry of weather elements and debris inside the holes 302, 304. Further, the cap device 100 is designed to absorb oil present inside the holes 302, 304, thereby preventing rusting of a tow bar inserted inside the holes 302, 304 during a towing operation.

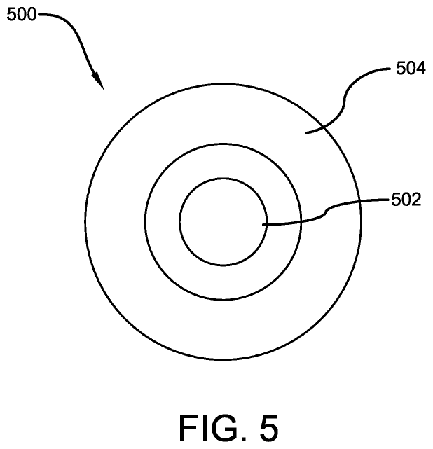

FIG. 5 illustrates a top view of another embodiment of the recess hole cap device of the present invention in accordance with the disclosed architecture. In the present embodiment, the device 500 includes a solar LED 502 disposed in the circular end 504 thereof. The solar LED 502 is configured to illuminate in dark and low light areas for enabling a user to locate recess holes disposed in the vehicle. The solar LED 502 recharges using solar energy and can illuminate in a single or multiple color in any conventional illumination manner such as continuous or flashing. The cap is adjustable in size to accommodate different sizes of holes and lengths, and may be stored in a convenient storage case when not in use and for easy transportation.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “flat tow recess hole protective cap”, “recess hole cap”, “protective cover”, “cap device”, and “device” are interchangeable and refer to the vehicle tow bar recess holes protective device 100, 500 of the present invention.

Notwithstanding the forgoing, the vehicle tow bar recess holes protective device 100, 500 of the present invention can be of any suitable size and configuration as is known in the art without affecting the overall concept of the invention, provided that it accomplishes the above stated objectives. One of ordinary skill in the art will appreciate that the vehicle tow bar recess holes protective device 100, 500 as shown in the FIGS. are for illustrative purposes only, and that many other sizes and shapes of the vehicle tow bar recess holes protective device 100, 500 are well within the scope of the present disclosure. Although the dimensions of the vehicle tow bar recess holes protective device 100, 500 are important design parameters for user convenience, the vehicle tow bar recess holes protective device 100, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flat tow recess hole protective cap comprising:
a protective recess hole cap having a one-piece structure including a circular first end, a generally rectilinear second end, a first cylindrical member extending from a bottom surface of said circular first end to a second cylindrical member;
wherein said second cylindrical member extending between said bottom surface of said first cylindrical member and a top end of said generally rectilinear second end;
wherein said first cylindrical member having a first length and said second cylindrical member having a second length;
wherein said first length of said first cylindrical member from six to twelve times said second length of said second cylindrical member; and
further wherein said hole cap is a protective cover for covering a recessed area used for accommodating an RV tow bar on a vehicle.

2. The flat tow recess hole protective cap of claim 1, wherein said first cylindrical member having a first diameter and said second cylindrical member having a second diameter.

3. The flat tow recess hole protective cap of claim 2, wherein said first diameter of said first cylindrical member from two to five times said second diameter of said second cylindrical member.

4. The flat tow recess hole protective cap of claim 3, wherein said hole cap comprising a flexible and oil-absorbing foam material.

5. The flat tow recess hole protective cap of claim 4, wherein said generally rectilinear second end, said first cylindrical member, and said second cylindrical member are inserted into the recessed area when said hole cap is mounted to the vehicle.

6. The flat tow recess hole protective cap of claim 5, wherein said hole cap is a pair of hole caps for protecting a pair of respective recessed areas, and further wherein the recessed areas accommodate an RV tow bar.

7. The flat tow recess hole protective cap of claim 6, wherein said circular first end abutting the vehicle exterior surface.

8. The flat tow recess hole protective cap of claim 7, wherein said circular first end of each said hole cap used for pulling out said hole caps from the respective recessed areas when a tow bar is to be used for towing the vehicle.

9. A flat tow recess hole protective cap comprising:
a protective recess hole cap having a one-piece structure including a first end, a generally rectilinear second end, a first cylindrical member extending from a bottom surface of said first end to a second cylindrical member;
wherein said first end having a generally circular shape including a circular top surface with a top diameter and a bottom surface with a bottom diameter;
wherein said top diameter is less than said bottom diameter;
wherein said first end having a tapered shape between said top surface and said bottom surface;
wherein said first end providing a grip for a user to hold said hole cap;
wherein said second cylindrical member extending between said bottom surface of said first cylindrical member and a top end of said generally rectilinear second end;
wherein said first cylindrical member having a first length and said second cylindrical member having a second length;
wherein said first length of said first cylindrical member from six to twelve times said second length of said second cylindrical member; and
further wherein said hole cap is a protective cover for covering a recessed area used for accommodating an RV tow bar on a vehicle.

10. The flat tow recess hole protective cap of claim 9, wherein said first cylindrical member having a first diameter and said second cylindrical member having a second diameter.

11. The flat tow recess hole protective cap of claim 10, wherein said first diameter of said first cylindrical member from two to five times said second diameter of said second cylindrical member.

12. The flat tow recess hole protective cap of claim 11, wherein said hole cap comprising a flexible and oil-absorbing foam material.

13. The flat tow recess hole protective cap of claim 12, wherein said generally rectilinear second end, said first cylindrical member, and said second cylindrical member are inserted into the recessed area when said hole cap is mounted to the vehicle.

14. The flat tow recess hole protective cap of claim 13, wherein said hole cap is a pair of hole caps for protecting a pair of respective recessed areas, and further wherein the recessed areas accommodate an RV tow bar.

15. The flat tow recess hole protective cap of claim 14, wherein said first end of each said hole cap used for pulling out said hole caps from the respective recessed areas when a tow bar is to be used for towing the vehicle.

16. The flat tow recess hole protective cap of claim 13, wherein said generally rectilinear second end rotatable relative to a vertical axis.

17. A method of protecting flat tow recessed areas, the method comprising the steps of:
providing a pair of protective hole caps;
wherein each said hole cap having a first end, a generally rectilinear second end, a first cylindrical member extending from a bottom surface of said first end to a second cylindrical member;
wherein said first end having a generally circular shape including a circular top surface with a top diameter and a bottom surface with a bottom diameter;
wherein said top diameter is less than said bottom diameter;
wherein said first end having a tapered shape between said top surface and said bottom surface;
wherein said second cylindrical member extending between said bottom surface of said first cylindrical member and a top end of said generally rectilinear second end;
wherein said first cylindrical member having a first length and said second cylindrical member having a second length;
wherein said first length is greater than said second length;
holding said first end as a grip for a user to insert and remove said hole cap from a recessed area of a vehicle;
inserting each said hole cap into a respective recessed area of the vehicle when the vehicle in not being towed; and
removing each said hole cap from the respective recessed area of the vehicle for accommodating an RV tow bar when the vehicle is being towed.

18. The method of protecting flat tow recessed areas of claim 17, wherein said first cylindrical member having a first diameter and said second cylindrical member having a second diameter, and further wherein said first diameter of said first cylindrical member greater than said second diameter of said second cylindrical member.

19. The method of protecting flat tow recessed areas of claim 17, wherein said hole cap comprising a flexible and oil-absorbing foam material.

20. The method of protecting flat tow recessed areas of claim 17, wherein removing each said hole cap comprising pulling on said first end of each said hole cap.
